(19) United States
(12) Patent Application Publication
(10) Pub. No.: US 2007/0082135 A1
(43) Pub. Date: Apr. 12, 2007

(54) Coating glass containers and labels

(76) Inventor: Vincent Lee, Short Hills, NJ (US)

Correspondence Address: Ashok Tankha;Lipton, Weinberger & Husick, 36 Greenleigh Drive, Sewell, NJ, 08080, US

(21) Appl. No.: 11/245,294

(22) Filed: Oct. 6, 2005

(51) Int. Cl. B05D 3/12

(52) U.S. Cl. 427/346

(57) ABSTRACT

A method is disclosed herein for uniformly coating the exterior surface of a glass bottle and the label affixed thereon to enhance the aesthetic appeal of the bottle and the label affixed thereon, to waterproof the label, and to allow the reuse of the label when the bottle is recycled without the need to remove or peel the label and reapply a new label. The method comprises preparing the clear coating to be applied on the surface of the bottle, rotating the bottle in a horizontal position about its center-line, applying the clear coating on the surface of the rotating bottle, adjusting the rotational speed of the bottle to allow the clear coating to spread uniformly over the surface of the bottle and the label affixed thereon, and allowing the applied coating to cure with or without the application of heat.

### BACKGROUND OF THE INVENTION

The present invention discloses a method for coating glass containers and the labels affixed thereon to enhance the aesthetic appeal of the glass container and by extension the product contained therein, and for water-proofing the labels.

The method disclosed herein for coating glass containers also allows a limited reuse of the labels when the bottles are recycled. One of the first steps in the recycling process of used beverage bottles is the stripping of the label from the surface of the glass bottle by chemical or mechanical means. This stripping process is a time consuming and relatively expensive process. The method disclosed in the present invention allows the reuse of the recycled bottle and the label affixed on the bottle without the need to strip away the label and the reapplication of a new label on the bottle.

The need for waterproofing labels also extends to commercial photography and to advertisements of beverage products where the labels on the beverage bottles are exposed to water or ice. Beverage makers are constantly challenged to make the label last a little longer in a water or ice environment without warping or peeling to allow the photographer to capture the perfect shot. If the labels warp or peel due to exposure to the water during the shooting, the entire advertisement sequence has to be re-shot with new bottles resulting in increased costs and wasted time. Beverage marketers are also challenged to show their products in advertisements as cold or chilled to enhance the appeal of the beverage. To simulate this chilled illusion on television and other commercial media, beads of water, termed “sweat” in the art, are trickled down the surface of the bottle. To produce this effect, labels and the graphics on the labels on beverage bottles are generally custom produced at a premium cost to withstand exposure to water. The method disclosed herein allows the beverage manufacturers to overcome both of the above problems by waterproofing the labels on the beverage bottles.

The method disclosed herein for coating a bottle and the label affixed thereon allows the reuse of labels on recycled bottles, enhances the aesthetic appeal of the bottle and by extension the product contained therein, creates the impression that the label is embedded within the glass surface, and enhances the beading effect of water on the surface of the bottle, a desired property in advertisement of chilled products.

### BRIEF DESCRIPTION OF DRAWINGS

FIG. 1 illustrates the apparatus used to coat the surface of the bottle and the label affixed thereon.

### DETAILED DESCRIPTION OF THE INVENTION

The proposed invention discloses a method for coating the surface of a bottle and the label affixed thereon to enhance the aesthetic appeal of the bottle and the label affixed thereon, to waterproof the label, and to allow the limited reuse of the label affixed on the bottle when the bottle is recycled without the need to remove or peel the label and reapply a new label.

The method comprises coating the exterior surface of the bottle and the label affixed thereon with a clear, waterproof coating, for example, clear epoxy coatings, clear alkyd coatings, clear resins coatings, polyurethane coatings, acrylic polymers such as methyl acrylate solvent based coatings, butyl acrylate co-polymerized with methyl methacrylate, etc. The coating may be applied by any method currently used in the art, for example, the clear coatings may be poured, or applied by a brush, or a spray gun on the exterior surface of the bottle with the bottle under rotation and with the center-line of the bottle in a horizontal plane. The bottle may also be momentarily immersed in a bath containing the coating and thereafter removed from the bath to leave a thin layer of the coating on the exterior surface of the bottle and thereafter placed under rotation as above. The rotational speed of the bottle is then adjusted to a speed sufficient to spread the coating uniformly over the surface of the bottle and the label affixed thereon. In one embodiment of the method disclosed herein, the coating is poured on the exterior surface of the bottle from a container through a funnel with the bottle under rotation and with the center-line of the bottle in a horizontal plane.

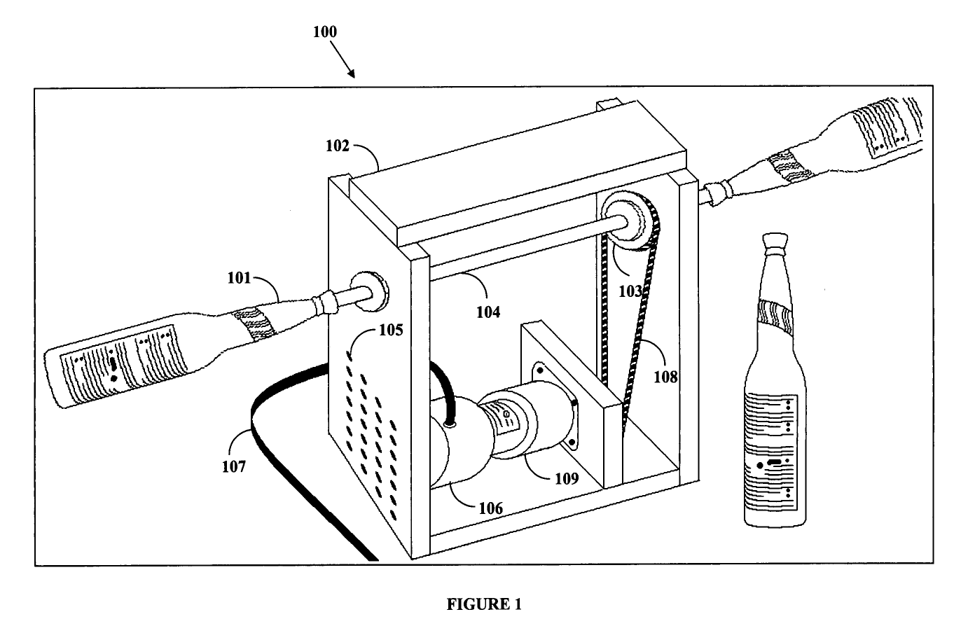

FIG. 1 illustrates an example of the apparatus 100 used to apply the coating on the exterior surface of the bottle 101 and the label affixed thereon. The housing assembly 102 houses a variable speed motor 106 and motor gear 109 that drives a chain 108 which rotates the sprocket 103. One end of the spindle 104 is connected to the sprocket 103 and the other end which is generally conical in shape is inserted through the corked mouth of the bottle 101 and secures the bottle with the center line of the bottle 101 in a horizontal plane. An alternating current is supplied through an A.C. power cord 107 to power the variable speed motor 106 which drives the gear assembly 109. The vent openings 105 protect the motor 106 from over-heating. The configuration of the housing, spindle and sprocket arrangement can be modified to rotate multiple bottles at the same time.

The rotational speed of the bottle 101 is adjustable via the variable speed motor 106. During the coating process, the rotational speed of the bottle is adjusted to allow the clear coating to spread uniformly as a thin film over the exterior surface of the bottle and the label affixed thereon. The rotational speed of the bottle is proportional to the viscosity of the coating and the affinity of the coating to the glass material used to manufacture the bottle.

The motor 106 is turned on and the axis of rotation of the bottle 101 is checked visually or by a horizontal aligning instrument to ensure the center-line of the bottle 101 is horizontal. The clear coating is then applied to the exterior surface of the bottle 101 under rotation by pouring the clear coating from a container on the exterior surface of the bottle 101 through a funnel. In another embodiment of the invention, the clear coating can be applied to the exterior surface of the bottle under rotation by a brush, or a spray gun. In yet another embodiment of the invention, the bottle to be coated is momentarily immersed in the coating and then placed under rotation with the center-line of the bottle in a horizontal plane. The rotational speed of the bottle 101 is then adjusted to spread the coating uniformly over the bottle 101 and the label affixed thereon. The coating is deposited as a thin, uniform film with a thickness of about 1 micron to about 100 micron on the surface of the bottle and the label affixed thereon. After the exterior surface of the bottle 101 and the label affixed thereon visually appear to be uniformly coated with the clear coating, depending on the coating characteristics, heat is applied to the surface of the bottle 101 to cure the coating. The heat may be provided by a conventional propane torch, blow torch, or hot air gun. Where the coating does not require heat to cure, the coating may be allowed to cure at ambient temperature over an extended period of time, for example, from about 1 day to about 3 days.

In one embodiment of the coating method disclosed herein, the coating applied to the surface of the bottle and the label affixed thereon is an epoxy based polymer marketed under the brand name Envirotex Lite by Environmental Technology, Inc., South Bay Depot Road, Fields Landing, CA 95537-0365. This epoxy based polymer coating is marketed as a two-part liquid mix. The first part is an epoxy hardener comprising nonyl phenol, polyoxyalkylenamines and N-aminoethylpiperazine, and the second part contains the epoxy resin bisphenol A, epichlorohydrin, aliphatic glycidyl ethers and aromatic glycidyl ethers. When these two parts are mixed, the components undergo a polymeric condensation reaction to form a clear coating which is applied to the exterior surface of the bottle and the label affixed thereon. The Envirotex Lite coating is poured on the exterior surface of the bottle 101 under rotation in the apparatus 100 using a conventional beaker and funnel arrangement. The rotational speed of the bottle 101 is then adjusted by adjusting the speed of the variable speed motor 106 to spread the coating uniformly over the exterior surface of the bottle 101 and the label affixed thereon. When the bottle 101 appears visually to be coated uniformly with the coating, the coating is cured by heating the surface of the bottle from about 1 second to about 60 seconds depending upon the temperature of the propane torch or hot air gun and the proximity of the heat source to the surface of the coated bottle 101. The coating on the bottle 101 can also be cured under ambient conditions with minimal or no application of heat, but the time to cure will increase from about 1 day to about 3 days depending on the ambient temperature. The clear coating hardens to a uniform, smooth, clear, glossy finish on the surface of the bottle 101 and the label affixed thereon.

In a production setting, the clear coatings may be applied on the exterior surface of the bottles by a spray gun and thereafter cured by conveying the coated bottles through a heated chamber. Any air bubbles formed on the surface of the bottle 101 during the coating process can be removed during the surface heating process. The thickness of the clear coating on the bottle 101 may be increased by applying another layer of the coating over the previously applied and cured coating on the bottle 101. In a commercial setting, the coating may be applied simultaneously to bottles moving along an assembly line.

It will be understood that the method disclosed herein for coating glass containers and the label affixed thereon is not limited to the examples described herein which are merely illustrative of embodiments for carrying out the invention, and which are susceptible to modification of form, size and arrangement of parts and details of operation. The method disclosed herein, rather is intended to encompass all such modifications within its spirit and scope, as defined by the claims.

I claim:

1. A method for coating the exterior surface of a glass bottle and the label affixed thereon comprising the steps of:
preparing the coating to be applied on the surface of the bottle,
rotating the bottle in a horizontal position about its center-line,
applying the coating on the surface of the rotating bottle,
adjusting the rotational speed of the bottle to spread the coating uniformly over the surface of the bottle and the label affixed thereon, and
allowing the coating to cure, with or without the application of heat to the surface of the bottle.

2. A method for coating the exterior surface of a glass bottle and the label affixed thereon comprising the steps of:
preparing a coating by mixing an epoxy hardener with an epoxy based resin, the epoxy hardener comprising nonyl phenol, polyoxyalkylenamines and N-aminoethylpiperazine, and the epoxy based resin comprising bisphenol A, epichlorohydrin, aliphatic glycidyl ethers and aromatic glycidyl ethers,
allowing the condensation reaction between the epoxy hardener and the epoxy based resin to proceed until the coating becomes clear,
applying the clear coating on the exterior surface of the bottle,
rotating the bottle in a horizontal position about its center-line at a rotational speed sufficient to spread the coating uniformly over the surface of the bottle and the label affixed thereon, and
allowing the coating to cure.

3. A method for coating the exterior surface of a glass bottle and the label affixed thereon comprising the steps of:
preparing a coating by mixing an epoxy hardener with an epoxy based resin, the epoxy hardener comprising nonyl phenol, polyoxyalkylenamines and N-aminoethylpiperazine, and the epoxy based resin comprising bisphenol A, epichlorohydrin, aliphatic glycidyl ethers and aromatic glycidyl ethers,
allowing the condensation reaction between the epoxy hardener and the epoxy based resin to proceed until the coating becomes clear,
rotating the bottle in a horizontal position about its center-line,
applying the clear coating on the exterior surface of the rotating bottle,
adjusting the rotational speed of the bottle to spread the coating uniformly over the surface of the bottle and the label affixed thereon, and
allowing the coating to cure.

4. The method of claim 1, wherein the cure is effected by the application of heat to the surface of the coated bottle by a propane torch, hot air gun, or by passing the coated bottle through a heated chamber.

5. The method of claim 1, wherein the coating is cured at ambient temperature.

6. The method of claim 1, wherein the coating is applied by pouring the coating along the exterior surface of the bottle, or by a brush, or by a spray gun, or by immersing the bottle in the coating.

7. The method of claim 1, wherein another coating is applied over the previously applied coating.

8. The method of claim 1, wherein the coating applied has a thickness of about 1 micron to about 100 micron.

9. The method of claim 2, wherein the cure is effected by the application of heat to the surface of the coated bottle by a propane torch, hot air gun, or by passing the coated bottle through a heated chamber.

10. The method of claim 2, wherein the coating is cured at ambient temperature.

11. The method of claim 2, wherein coating is applied by a brush, or by a spray gun, or by immersing the bottle in the coating.

12. The method of claim 2, wherein another coating is applied over the previously applied coating.

13. The method of claim 2, wherein the coating applied has a thickness of about 1 micron to about 100 micron.

14. The method of claim 3, wherein the cure is effected by the application of heat to the surface of the coated bottle by a conventional hot air gun, blowtorch, or by passing the coated bottle through a heated chamber.

15. The method of claim 3, wherein the coating is cured at ambient temperature.

16. The method of claim 3, wherein the coating is applied by pouring the coating along the exterior surface of the bottle, or by a brush, or by a spray gun, or by immersing the bottle in the coating.

17. The method of claim 3, wherein another coating is applied over a previously applied coating.

18. The method of claim 3, wherein the coating applied has a thickness of about 1 micron to about 100 micron.

19. An apparatus for coating a bottle and the label affixed thereon comprising a spindle that holds said bottle, said spindle connected to a sprocket, said sprocket in communication with a motor-gear, said motor gear driven by a a variable speed motor, wherein the rotation of the motor rotates the bottle.
